(19) United States
(12) Patent Application Publication
(10) Pub. No.: US 2006/0224423 A1
(43) Pub. Date: Oct. 5, 2006

(54) Transportation planning with parallel optimization

(75) Inventors: Rongming Sun, Hayward, CA (US); Mukundan Srinivasan, Foster City, CA (US); Georges-Henri Moll, Villeneuve-Loubet (FR); Vinay Muralidhara Yadappanavar, Redwood City, CA (US); Mei Yang, Albany, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/097,435

(22) Filed: Apr. 1, 2005

(51) Int. Cl. G06F 9/44

(52) U.S. Cl. 705/7

(57) ABSTRACT

Systems, methodologies, media, and other embodiments associated with parallel optimization in transportation planning are described. One exemplary method embodiment may include selecting, in parallel, candidate loads to satisfy a set of orders, selecting final loads from the candidate loads, and in parallel selectively manipulating the final loads into a transportation plan that reduces a transportation cost.

### BACKGROUND

Conventionally, transportation planning systems may have followed a traditional serial input-process-output methodology. This type of processing may lead to an exponentially expanding problem space and require backtracking through a developing solution space, which may in turn require unacceptable amounts of processing power and time. Conventional systems may struggle with trying to solve different problems using different approaches to find optimal combinations of solutions. For example, optimization may include tasks like routing vehicles, which by itself is a nondeterministic polynomial (NP) hard problem, selecting pooling points, identifying consolidation opportunities, and selecting carriers, all while considering potentially conflicting constraints like vehicle capacity and desired vehicle utilization percentage.

### BRIEF DESCRIPTION OF THE DRAWINGS

The accompanying drawings, which are incorporated in and constitute a part of the specification, illustrate various example systems, methods, and so on that illustrate various example embodiments of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Of course, embodiments and/or elements can be combined with other embodiments to produce variations of the systems and methods, and their equivalents.

FIG. 1 illustrates an example method for transportation planning with parallel optimization.

FIG. 2 illustrates another example method for transportation planning with parallel optimization.

FIG. 3 illustrates an example system associated with transportation planning with parallel optimization.

FIG. 4 illustrates another example system associated with transportation planning with parallel optimization.

FIG. 5 illustrates an example computing environment in which example systems and methods illustrated herein can be implemented and/or can operate.

FIG. 6 illustrates an example API associated with transportation planning with parallel optimization.

FIG. 7 illustrates concepts associated with consolidation.

FIG. 8 also illustrates concepts associated with consolidation.

FIG. 9 illustrates example parallel processing flows.

### DETAILED DESCRIPTION

Example transportation planning systems and methods may attempt to minimize transportation costs by taking actions like consolidating loads, planning continuous moves, selecting carriage modes, selecting carriers, and so on. Example transportation planning systems and methods may also attempt to improve performance in areas like on-time delivery, customer satisfaction, compliance with routing guides, using preferred carriers, exploiting volume-based pricing, and so on. Given the highly complicated transportation network, which includes highway, railroad, air and sea, the variety of carriers and carriage modes, and so on, problems associated with transportation planning may become extremely complicated. Particularly when transportation planning systems try to find optimal solutions that balance different constraints while trying to minimize total transportation costs.

Thus, example systems, methods, media, and other embodiments described herein relate to transportation planning with parallel optimization. Example systems and methods may employ multiple, parallel, configurable, problem-solving sequences that provide optimal or near optimal sub-solutions to transportation planning problems while considering multiple constraints and/or cost factors. Example systems and methods may then manipulate (e.g., partition) the sub-solutions to facilitate creating optimal or near optimal overall solutions by selecting from the sub-solutions. In some examples, optimal and/or near optimal refers to solutions that facilitate reducing transportation costs and/or improving a utility measure for a transportation plan.

In one example, computer-based systems and methods that may participate in consolidating orders, planning loads, assigning consolidated orders to loads, selecting carriers, and so on may be configured to produce, substantially simultaneously, different candidate solutions for covering (e.g., satisfying) orders. The different candidate solutions may be produced using different strategies implemented using different algorithms embodied in different logics. In one example, different logics may produce the different candidate solutions substantially in parallel. As acceptable sub-solutions are produced, orders covered by the sub-solutions may be logically removed from further consideration while further processing continues. At different times, an overseeing logic may select different candidate solutions from the developing set of candidate solutions in such a way that orders are covered once and only once by loads in the actionable plan of loads.

Traveling different optimization paths in parallel to produce candidate solutions, when coupled with an overseeing selection logic that is configured to select acceptable sub-solutions from candidate solutions facilitates removing backtracking from multi-criteria problems. Since there is no way of knowing beforehand which algorithms or logics will yield optimal solutions and since there is no way of knowing beforehand which decisions will yield optimal solutions, conventional systems frequently have to backtrack in a solution space. Thus, example systems and methods use an architecture that allows multiple strategies to progress in parallel while also facilitating pruning both the problem space (e.g., uncovered orders) and the solution space (e.g., scheduled loads) as the multiple strategies advance. This facilitates making a complicated decision without committing to that decision and without having that complicated decision necessarily negatively impact other decisions being made in parallel.

Consider solving a jigsaw puzzle with your family on a rainy day at the beach house. You may search for corner pieces and edge pieces and try to arrange them into a frame. Your spouse may like clouds and thus may search for the pieces that represent clouds and arrange them around the top of your developing frame. Your son may like dogs and thus may search for pieces that represent dogs and arrange them near the bottom of your frame. Your daughter may like horses and thus may search for pieces that represent horses and arrange them outside your frame. Each of you is likely employing a different mental process to identify, select, and arrange puzzle pieces. Yet you are each working in parallel to reduce the problem space (e.g., unarranged pieces). While you may be looking for edges, you may notice a dog ear and provide it to your son. Similarly, your spouse may notice an edge piece and fit it into your frame. Thus, each of you is contributing to reducing the problem space while contributing to increasing the solution space (e.g., accounted for arranged pieces). From time to time, a dog or horse may be completed and positioned in the frame according to the picture on the puzzle box. Your stand-offish teenager may decide not to pick and place pieces since puzzles are “stupid” but may hover nearby and occasionally jump in with the observation that a set of dog pieces can be arranged near a set of horse pieces and the combination can be positioned in a certain part of the frame. Thus, the teenager may perform an oversight role that selects partial solutions from the developing solution space to contribute to the overall optimal solution. Eventually the puzzle will be solved, likely in less time than a person working alone would take. While this puzzle example is much less complicated than a transportation planning system that uses parallel optimization strategies, it illustrates some of the benefits of co-operative, multi-strategy parallel processing.

Transportation planning generally concerns determining how and when to ship items from sources to destinations. As used herein, transportation planning refers to computer-based determining of how to interact with carriers who will be tasked with shipping items using vehicles like trucks. While trucks are described, it is to be appreciated that example systems and methods may facilitate planning for interacting with carriers that use other vehicles like trains, planes, and so on. Also, in some examples, “carriers” may include not only external transportation providers but also equipment owned, managed, and/or operated by the planning organization, and/or by other units of the same corporate, governmental, or other entity. Transportation planning may include planning actions and execution actions.

Unique elements of the North American regional transportation system lead to extensive truck utilization. The unique elements include long distances between major cities, an extensive high quality, government subsidized road network, relatively low fuel costs, a highly organized and competitive trucking industry, comparatively poor rail service over a relatively limited rail network, and a high level of economic activity over very dense traffic lanes. Thus, systems and methods that participate in truck based transportation planning may facilitate mitigating some inefficiencies associated with truck utilization.

A transportation management system may include components like a planning component and an execution component. The planning component may perform tasks like consolidating orders into shipments, assigning shipments to loads, selecting load routes, selecting carriers, determining the order in which shipments are loaded on a truck, and so on. The results of these tasks may be recorded, for example, in a transportation plan that includes an actionable plan of loads. The transportation plan may be communicated to the execution component. The execution component may then perform tasks like rating, tendering, booking, tracing/tracking, and so on. However, a plan produced automatically using a conventional serial input-process-output architecture may include suboptimal loads due, for example, to processing time and/or processing power issues.

The following includes definitions of selected terms employed herein. The definitions include various examples and/or forms of components that fall within the scope of a term and that may be used for implementation. The examples are not intended to be limiting. Both singular and plural forms of terms may be within the definitions even when only a singular term is used.

In the context of transportation planning and this application, “load” refers to a set of shipments assigned to a vehicle and assigned a schedule for delivery. A load may refer to a single stop load, a multi-stop load, and the like.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication” or “network communication”, as used herein, refers to a communication, direct or indirect, between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Heuristic”, as used herein, refers to programming based on rules (e.g., “common sense” rules) that may, for example, be drawn from experience. Heuristics contrast with algorithmic programs that are based on mathematically provable procedures. In some examples, heuristics may include rules that are adaptable by self-learning.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, logic, software, or other entity. In the context of a network connection, an operable connection may be created though one or more computing devices and network components. Logical and/or physical communication channels can be used to create an operable connection.

“Signal”, as used herein, includes but is not limited to one or more electrical or optical signals, analog or digital signals, a bit or bit stream, and/or other means that can be received, transmitted and/or detected. A signal can also take other forms like data, one or more computer or processor instructions, messages, and the like.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firm ware as it is maintained on the web server. Other forms may also be used.

“User”, as used herein, includes but is not limited to one or more persons, software, computers or other devices, or combinations of these.

Some portions of the detailed descriptions that follow are presented in terms of methods, algorithms, and/or symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is to be appreciated that throughout the description, terms like processing, intercepting, storing, redirecting, detecting, determining, displaying, or the like, refer to actions and processes of a computer system, logic, processor, or similar electronic device that manipulates and/or transforms data represented as physical (electronic) quantities.

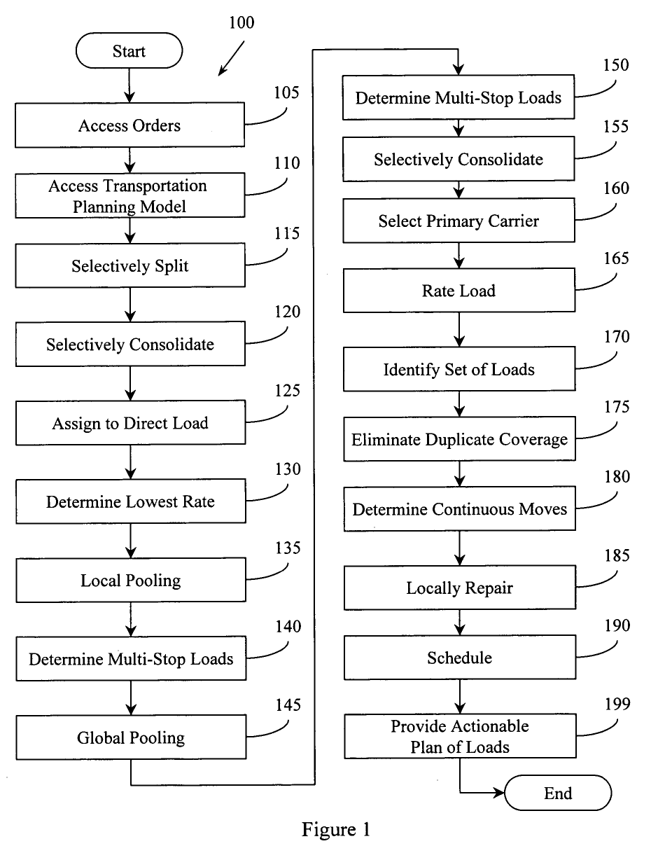

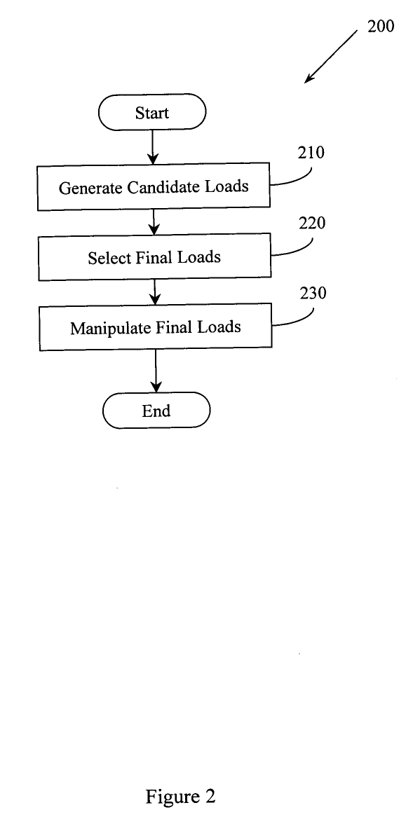

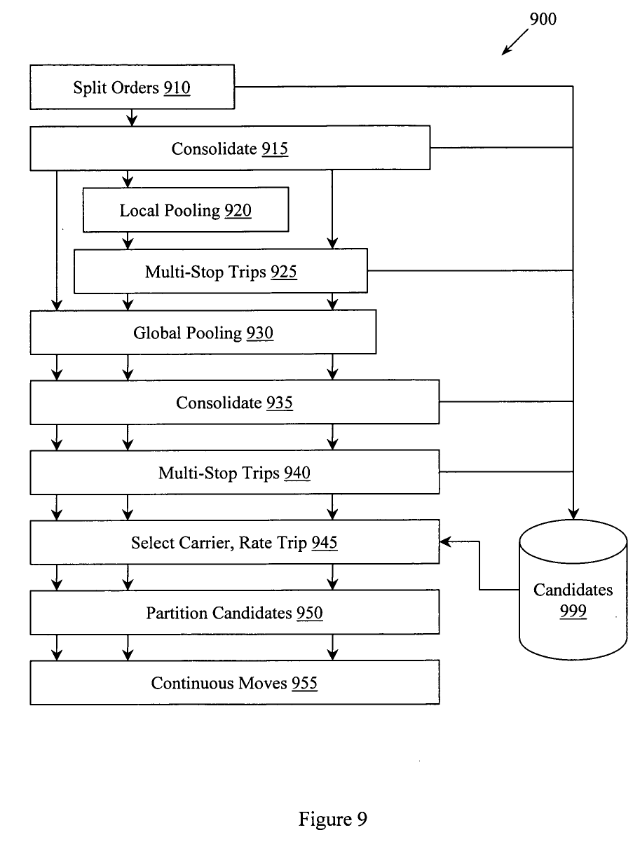

Example methods may be better appreciated with reference to the flow diagrams of FIGS. 1 and 2. While for purposes of simplicity of explanation, the illustrated methodologies are shown and described as a series of blocks, it is to be appreciated that the methodologies are not limited by the order of the blocks, as some blocks can occur in different orders, occur at different times, and/or occur concurrently with other blocks from that shown and described. Moreover, less than all the illustrated blocks may be required to implement an example methodology. Furthermore, additional and/or alternative methodologies can employ additional, not illustrated blocks. To illustrate the flexibility in a method like that illustrated in FIG. 1, FIG. 9 illustrates example processing sequences that may be performed in parallel to facilitate transportation planning.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 1 illustrates an example computer-implemented method 100 that is associated with transportation planning with parallel optimization. Method 100 may include, at 105, accessing a set of orders. An order may describe, for example, an item(s) that is to be delivered to a facility. How, when, how much to deliver, and so on may be described by order requirements associated with the order. Order requirements may also include, for example, an earliest time at which the order may be picked up, a latest time at which the order may be picked up, the earliest time at which the order can be delivered, the latest time at which the order can be delivered, a source location for the order, a destination for the order, and so on. Accessing the set of orders may include, for example, receiving orders via computer communications, reading orders stored in a data store, and so on.

Method 100 may also include, at 110, accessing a transportation planning model. The transportation planning model may include, for example, information concerning modes by which an order may be shipped like a parcel mode, a less than truckload mode, a truckload mode, and so on. The transportation planning model may also include information concerning carriers by which an order can be delivered to a facility. The carriers may include, for example, parcel carriers, less than truckload carriers, truckload carriers, and so on. The transportation planning model may also include, for example, rates charged by the carriers to carry an item(s) according to the modes, facilities from which items are carried, facilities to which the items are carried, consolidation points through which items pass, cross-docking locations across which items pass, a transportation network (e.g., roads) upon which the carriers travel, and so on. Accessing the transportation planning model may include, for example, receiving the model in a computer communication, reading the model from a data store, connecting to the model in a logic, and so on.

Method 100 may also include, at 115, selectively splitting orders. Splitting orders may include, for example, selectively splitting an order that exceeds a threshold size (e.g., truckload) into two, three or more shipments. The resulting shipments would each be less than the threshold size.

Method 100 may also include, at 120, selectively consolidating shipments. Whether shipments are consolidated may depend on factors like common origins, common destinations, requirements that sets of items remain together in transit, requirements that sets of items be delivered together, the existence of an under-utilized truck moving along a path that satisfies the order, and so on.

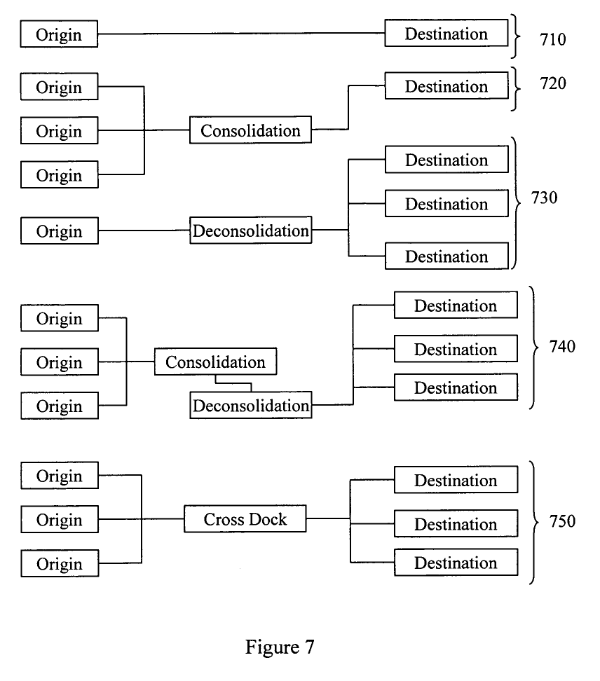

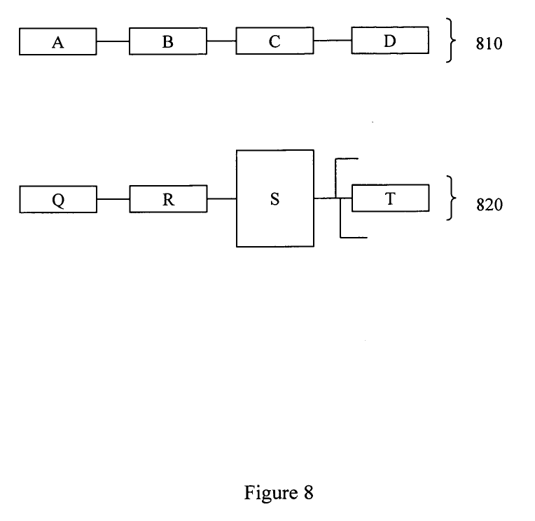

In one example, a decision concerning whether to consolidate shipments may include identifying consolidation opportunities. In different examples, consolidation opportunities may include, for example, a simple consolidation opportunity, a single tier pooling opportunity, a multi-tier pooling opportunity, a cross docking opportunity, and a multi-stop load opportunity. Examples of these consolidation opportunities are described in association with FIGS. 7 and 8.

As is known in the art, there are a variety of algorithms and processes by which items can be selected to be included or not included in a group like a consolidated shipment. However, these algorithms conventionally may not have been configured to operate in parallel with other algorithms or other algorithm instances that share a problem space like the set of orders. The algorithms may be implemented, for example, in processes including, but not limited to, linear programming processes, simplex method processes, dynamic programming processes, greedy algorithm processes, look ahead processes, divide and conquer processes, branch and bound processes, savings-based processes, heuristic-based processes (e.g., bin picking heuristics) and the like.

Consider dynamic programming, which may be used to solve optimization problems that may require testing many possible solutions. When presented with a set of orders, many possible solutions for consolidation, routing, load assignment, and so on may be available. Conventionally, dynamic programming techniques may not have worked in parallel with other strategies when calculating acceptable and/or optimal solutions in the transportation planning field. Thus, example systems and methods described herein may be configured to include multiple logics and/or processes that operate in parallel on a problem space (e.g., orders) to co-operatively reduce the problem space and build the solution space (e.g., loads).

Dynamic programming involves breaking problems into dependent sub-problems, solving the sub-problems, and saving the solutions for reuse when applicable. In dynamic programming, the single best solution is referred to as the optimal solution. In some examples, neither the time nor the computing cycles may be available to compute an optimal solution. However, the time and computing cycles may be available to identify optimal or near optimal sub-solutions, particularly when the sub-solutions can be explored in parallel. In other examples, a sub-optimal solution may be acceptable, particularly if it can be computed within a desired time frame. Thus, example systems and methods described herein may employ solutions that are configured to produce, in parallel, “good-enough” solutions that may then be selected between by a later operating and/or simultaneously operating oversight or selection logic. While dynamic programming is described, it is to be appreciated that similar improvements may be made in other techniques like greedy algorithms, divide and conquer, and so on.

Greedy algorithms concern a general algorithm design paradigm that rests on the consideration of configurations and objective functions. A configuration describes different choices to make, different collections to assemble, different values to find, and so on. An objective function describes a score that may be assigned to candidate configurations. Thus, transportation planning may employ greedy algorithms whose objective functions concern cost and/or utility and whose configurations describe orders, consolidations, routes, assignments, and so on. Greedy algorithms seek to maximize or minimize the objective function. A greedy algorithm builds a solution by keeping the best result for a smaller problem and adding that result to a current sub-solution. One example smaller problem may be identifying loads that violate an hours of service rule and another smaller problem may be identifying trucks that are under-utilized. A greedy algorithm tends to make the best choice at the moment in the hope that this will lead to an optimal and/or acceptable solution in the long run. Example greedy algorithms include Dijkstra's shortest path algorithm, Prim/Kruskal's MST algorithm, and so on. Greedy algorithms are typically employed to solve task scheduling and knapsack like problems. Greedy algorithms may typically backtrack to various decision points when a sub-optimal solution is derived. However, this backtracking may be unacceptable in terms of time and effect on problem space reduction. Thus, in some examples, a greedy algorithm and/or other potentially backtracking algorithms may be adapted to only move forward. Additionally, and/or alternatively, example systems and methods may be configured to employ additional logics and/or to spawn additional processes when an important decision is to be made. Thus, multiple paths leading forward from the decision may be followed substantially simultaneously and a selection logic may choose between the different solutions produced.

A look ahead algorithm does not necessarily make the best choice at the moment, but rather makes “tentative” decisions and determines the best result based on subsequent decisions. Look ahead algorithms are familiar to those involved in chess programming. Divide and conquer programming involves breaking problems into independent sub-problems and solving the sub-problems. Linear programming is used to solve problems that involve limited resources, an overall objective, and a choice of actions to be taken. The simplex method is a pre-eminent tool in linear programming. Example systems and methods may employ, simultaneously and/or substantially simultaneously, different processes based on different algorithmic approaches.

Method 100 may also include, at 125, selectively assigning a shipment(s) to a direct load. In one example, a shipment may be assigned to a direct load based, at least in part, on a bin-packing heuristic. Whether shipments are assigned to loads may depend on factors like common origins, common destinations, common pickup windows, common delivery windows, and so on. For multi-stop loads, whether shipments are assigned to loads may depend on factors like the proximity of origins, the proximity of destinations, compatibilities involving commodities, equipment, carriers, facilities, and so on. Selectively assigning shipments to loads may also include identifying a routing opportunity for a shipment(s). A routing opportunity may include, for example, a single stop routing opportunity, a multi-stop routing opportunity, a continuous move opportunity, and so on. A continuous move is a sequence of loads that a single vehicle can serve as one mission. A continuous move may have empty movements between loaded legs.

Once again, routing algorithms known in the art may include, but are not limited to, vehicle routing problem (VRP) processes, linear programming routing processes, simplex method routing processes, dynamic programming routing processes, greedy algorithm routing processes, look ahead routing processes, divide and conquer routing processes, branch and bound routing processes, savings-based routing processes, heuristic-based routing processes, and so on. Example systems and methods may be configured with forward looking parallel processing examples of these algorithms to facilitate problem space reduction without backtracking.

Method 100 may also include, at 130, determining a lowest rate for the direct load. Determining the lowest rate may include, for example, identifying a carriage mode, a carrier, a schedule, and so on. While a “lowest” rate is described, it is to be appreciated that in some examples an “acceptable” rate or rates may be determined and subsequent decisions may determine which rate to employ.

After the actions of 105 through 130, some orders may be associated with loads that satisfy the orders. However, other orders may not yet be satisfied. Thus, multiple parallel instances of actions 135 through 165 may be performed to determine loads that satisfy more orders.

Thus, method 100 may also include, at 135, selecting members of the set of orders to be considered for loads influenced by local pooling decisions, and at 145, selecting orders to be considered for loads influenced by global pooling decisions. In one example, orders are selected to participate in pooling based, at least in part, on order characteristics like order size, the distance from the origin of the order to a pooling point, the distance from the destination for an order to a pooling point, and so on. As used herein, “global pooling” refers to a pooling strategy that seeks to consolidate/deconsolidate/crossdock by simultaneously considering multiple orders that may have different origins and destinations based on global cost savings. “Local pooling” refers to a strategy that considers each order, or group of orders that share the same origin and destination, separately based on cost savings for that order alone.

Method 100 may also include, at 140, determining multi-stop loads that visit a pooling point and that satisfy an order and at 150, determining multi-stop loads that visit a pooling point and that satisfy an order. In one example, the multi-stop loads may be determined based, at least in part, on an origin neighborhood or a destination neighborhood. In another example, orders may be selected to participate in pooling based, at least in part, on a mixed integer problem (MIP) model. In different examples, the multi-stop loads may include a load that is determined as a single pickup, multiple drop off load based, at least in part, on a single origin vehicle routing problem (VRP) heuristic. Similarly, the multi-stop loads may include a load that is determined as a multiple pickup, single drop off load based, at least in part, on a single destination VRP heuristic or a mirror to the single origin VRP heuristic. Additionally, the multi-stop loads may include a load determined from an existing load, where the existing load is expanded to accommodate a new delivery based, at least in part, on a pickup/drop-off problem (PDP) heuristic.

Method 100 may also include, at 155, selectively consolidating shipments that share at least two common points and, at 160, selecting a primary carrier for a load. Selecting shipments to consolidate may depend on factors like common origins for shipments, common destinations for shipments, requirements that sets of items remain together in transit, requirements that sets of items be delivered together, and so on. Deciding whether to consolidate shipments may include identifying consolidation opportunities (e.g., simple consolidation, single tier pooling, multi-tier pooling, cross docking, multi-stop load) like those illustrated in FIGS. 7 and 8.

Method 100 may also include, at 165, using the primary carrier to rate the load. In one example, selecting a primary carrier may include considering carrier related constraints like carrier availability, carrier discount, carrier commitments, and carrier/product compatibility. By way of illustration, while a first carrier may have a better rate for a certain lane, that carrier may not have sufficient availability, and thus a different carrier with an acceptable rate and capacity available may be selected.

Method 100 may also include, at 170, identifying a set of loads that satisfies a threshold amount of orders. The threshold may be, for example, 100% of the orders, a lesser amount of orders, and so on. The threshold may be, for example, user configurable. Furthermore, the set of loads may be required to satisfy and/or maximize an overall utility measurement for the transportation plan.

Method 100 may also include, at 175, selectively removing a load from the set of loads if it is determined that the load provides duplicate coverage for an order. Thus, method 100 facilitates producing an actionable plan of loads that cover orders once and only once.

Method 100 may also include, at 180, determining continuous move loads that can be built from loads in the set of loads. Determining a continuous move load may include, for example, identifying that an additional move will improve a utility measure for a continuous move load and then adding the additional move to the continuous move load. Action 180 may continue to evaluate additional moves until no additional move can be identified that would improve the utility measure for the continuous move load beyond a threshold improvement amount. In one example, the threshold improvement amount may be user configurable.

Method 100 may also include, at 185, selectively locally repairing a carrier selection for a load. In one example, locally repairing a carrier selection for a load may involve identifying a carrier related constraint that is violated for a load. Additionally, and/or alternatively, locally repairing the carrier selection may involve identifying a carrier commitment rule that is broken for a load. While constraints and commitment rules are described, it is to be appreciated that other rules may also be examined. After identifying constraints and/or rules, local repairing may include reconfiguring a load so that the constraints and/or rules are no longer violated.

Method 100 may also include, at 190, scheduling the set of loads into a scheduled set of loads. Scheduling a load may include manipulating the timing of a load. The manipulating may be based on factors like a selected carrier, a chosen service, a carriage mode, a lane across which the load will travel, an order pickup window, an order drop-off window, a precedence relationship between order legs, a facility loading speed, a facility unloading speed, a facility required flow thru time, a federal layover regulation rule, and the like.

Method 100 may also include, at 199, providing an actionable plan of loads from the scheduled set of loads. The actionable plan of loads may be configurable to satisfy a threshold percentage of the orders exactly once. Inclusion of a load in the actionable plan of loads may be based, at least in part, on a mixed integer problem (MIP) set partitioning model. The actionable plan may be provided, for example, on a computer-readable medium like a disk, a CD, a DVD, and so on. In one example, the actionable plan and/or portions thereof may be distributed to carriers by, for example, the Internet. In this case, the computer-readable medium may take the form of a carrier wave. The loads may be described by data including, for example, a start time, a start location, a sequenced set of stops, and a set of shipments involved in the load. It is to be appreciated that in some examples a load may include multiple stops, that some items may be dropped off at a stop and that other items may be picked up at a stop.

In one example, actions like splitting orders at 115, consolidating shipments at 120 and/or 155, assigning shipments to loads at 125, selecting orders to participate in pooling at 135 and/or 145, determining loads at 140, 150, and/or 180, selecting carriers at 160, repairing loads at 185, and scheduling loads at 190 may be performed in parallel by processes like linear programming processes, simplex method processes, dynamic programming processes, greedy algorithm processes, look ahead processes, divide and conquer processes, branch and bound processes, savings-based processes, and heuristic-based processes.

FIG. 2 illustrates an example method 200 for using parallel optimization processes in transportation planning. Method 200 may include, at 210, generating a set of candidate loads that satisfy a set of orders. The candidate loads may be generated in parallel. Generating the set of candidate loads may include taking actions like splitting orders, consolidating orders, determining direct loads, determining multi-stop loads, selecting pooling points, and determining loads that include pooling points.

Method 200 may also include, at 220, selecting a set of final loads from the set of candidate loads. In different examples the set of final loads may be selected all at once and/or may be selected on the fly as acceptable and/or highly desirable loads are generated.

Method 200 may also include, at 230, manipulating the set of final loads into a transportation plan that reduces a transportation cost associated with satisfying the orders. The manipulating may be done in parallel. Manipulating the set of final loads may include taking actions like selecting a carriage mode, selecting a carrier, determining a schedule, and so on.

While FIG. 2 illustrates various actions occurring in serial, it is to be appreciated that various actions illustrated in FIG. 2 could occur substantially in parallel. By way of illustration, a first process could generate candidate loads, a second process could select loads for manipulation and inclusion in a transportation plan, and a third process could manipulate the selected loads. It is to be appreciated that other methods may also occur substantially in parallel.

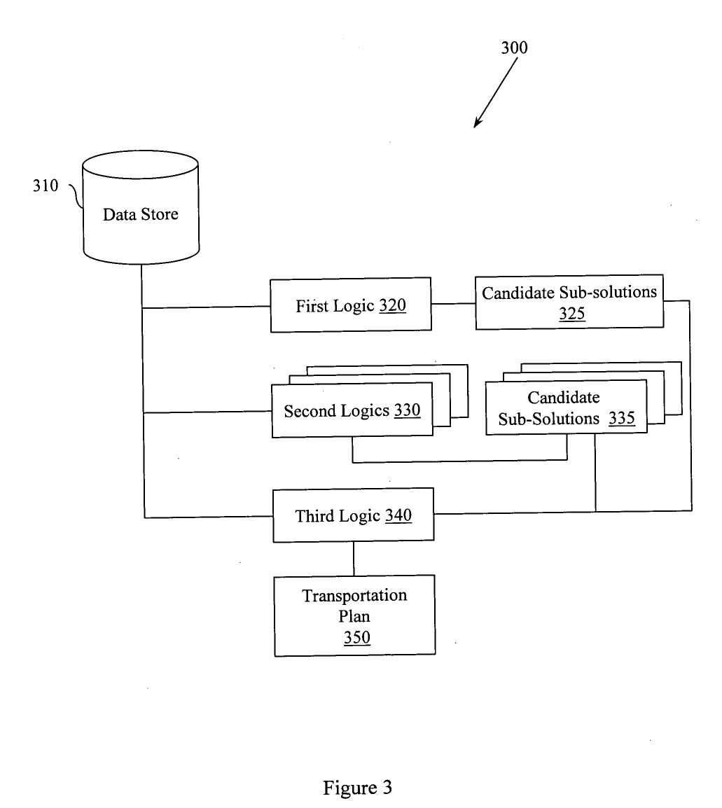

FIG. 3 illustrates an example system 300 associated with transportation planning with parallel optimization. System 300 includes a data store 310 that is configured to store orders for which a transportation plan is to be computed. An order describes an item(s) to be delivered to a facility in accordance with an order requirement. How, when, how much to deliver, and so on may be described by order requirements associated with the order. Order requirements may also include, for example, an earliest time at which the order may be picked up, a latest time at which the order may be picked up, the earliest time at which the order can be delivered, the latest time at which the order can be delivered, a source location for the order, and a destination for the order.

Data store 310 may also be configured to store a shipping model. While a single data store 310 is illustrated, it is to be appreciated that the orders and shipping model may be stored in separate data stores. The shipping model may describe, for example, shipping modes, carriers, facilities, a transportation network, constraints associated with carriers, facilities, commodities, and so on. Additionally, the shipping model may include data concerning factors relevant to shipping an item from a source to a destination like a transportation network configuration, the capacity of various types of equipment, transit times across portions of the transportation network, commodity to commodity compatibilities, commodity to equipment compatibilities, commodity to facility compatibilities, commodity to carrier compatibilities, facility to equipment compatibilities, rules for carriers, carrier limits, laws concerning hours of service for drivers and/or equipment, days on which a facility may be open, hours during which a facility may operate, the availability of equipment (e.g., tractors, trailers), the availability of drivers, the capacity of a facility, carrier pickup lead times, groups of items that need to be shipped together, and so on.

System 300 may include a first logic 320 that is operably connected to data store 310. First logic 320 may be configured to produce a first set of candidate sub-solutions 325 that cover orders. The candidate sub-solutions 325 may include, for example, candidate loads. Covering an order refers to satisfying the order so that order requirements (e.g., delivery amount, delivery time) are met. First logic 320 may be configured to use a variety of processes for producing the sub-solutions 325. For example, first logic 320 may use a linear programming process, a simplex method process, a dynamic programming process, a greedy process, a look ahead process, a divide and conquer process, a branch and bound process, a savings-based process, and/or a heuristic-based process to perform actions involved in making a sub-solution like simple consolidation, complex consolidation, route planning, pooling point selection, load repairing, load scheduling, carrier selection, trip rating, and so on.

Whether and/or how orders are consolidated into shipments may depend, for example, on the shipping model. In one example, first logic 320 may be configured to identify a consolidation opportunity and then to make consolidations based on the identified opportunities. Opportunities may be identified using, for example, a linear programming selection process, a simplex method selection process, a dynamic programming selection process, a greedy selection process, a look ahead selection process, a divide and conquer selection process, a branch and bound process, a savings-based process, a heuristic-based process, and so on. Opportunities may include, for example, simple consolidation opportunities, single tier pooling opportunities, multi-tier pooling opportunities, cross docking opportunities, multi-stop pooling opportunities, and so on like those identified in FIGS. 7 and 8.

System 300 may also include second logics 330 that are operably connected to data store 310. Second logics 330 may be configured to produce second sets of candidate sub-solutions 335 that also cover orders. Second logics 330 may be configured to employ a variety of second processes operating in parallel to produce the second sets 335 of sub-solutions. In different examples, second logics 330 may employ linear programming processes, simplex method processes, dynamic programming processes, greedy processes, look ahead processes, divide and conquer processes, branch and bound processes, savings-based processes, heuristic-based processes, and the like to perform actions like simple consolidation, complex consolidation, route planning, pooling point selection, load repairing, load scheduling, carrier selection, trip rating, and so on.

System 300 may also include a third logic 340 that is operably connected to first logic 320, second logic 330, and data store 310. Third logic 340 may be configured to select sub-solutions from candidate sub-solutions 325. Third logic 340 may also be configured to select sub-solutions from candidate sub-solutions 335. Based on the selected sub-solutions, third logic 340 may be configured to logically remove orders from data store 310 and to add loads associated with a sub-solution to transportation plan 350. The selected sub-solutions (e.g., loads) may be organized into a transportation plan 350. Loads in the transportation plan 350 may satisfy orders exactly once. In one example, the collection of loads in the transportation plan 350 may satisfy a transportation planning threshold utility.

In system 300, first logic 320, second logics 330, and third logic 340 may be configured to operate substantially in parallel.

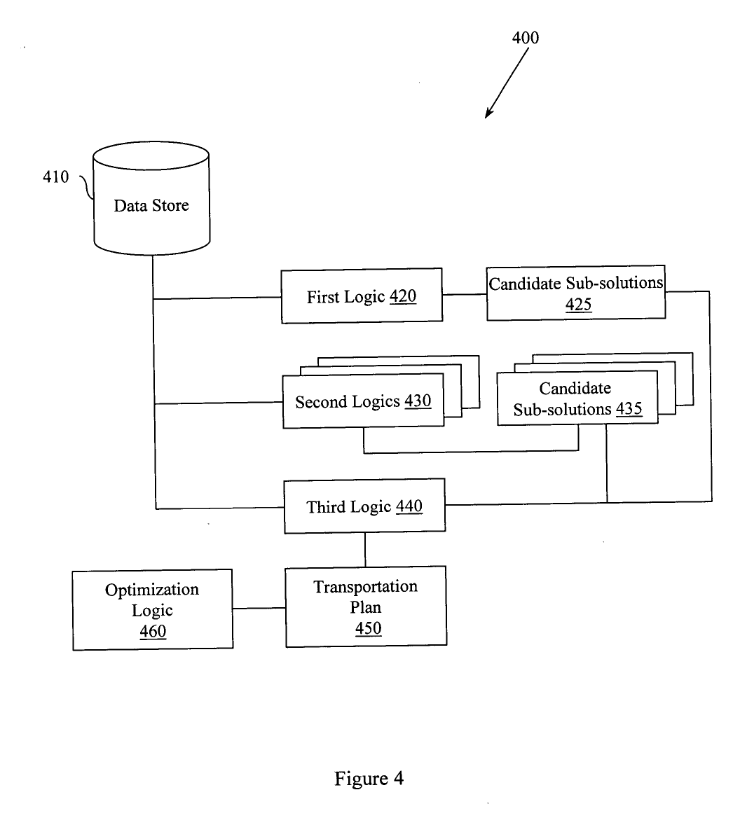

FIG. 4 illustrates an example system 400 associated with transportation planning with parallel optimization. System 400 may include elements 410 through 440 that are similar to components 310 through 340 (FIG. 3). Additionally, system 400 may include a post-selection optimization logic 460 that is configured to manipulate selected sub-solutions to improve a utility measurement associated with the transportation plan. Manipulating the selected sub-solutions may include, for example, taking actions like selecting a carriage mode, selecting a carrier, determining a schedule, and so on.

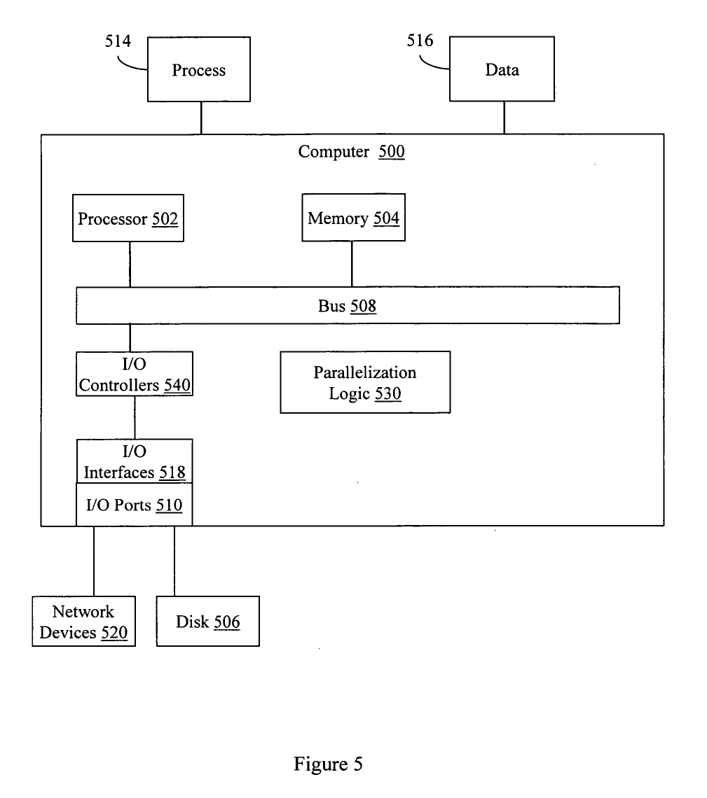

FIG. 5 illustrates an example computing device in which example systems and methods described herein, and equivalents, can operate. The example computing device may be a computer 500 that includes a processor 502, a memory 504, and input/output ports 510 operably connected by a bus 508. In one example, the computer 500 may include a parallelization logic 530 that is configured to facilitate operating transportation planning optimization processes and/or logics in parallel. Parallelization logic 530 may implement portions of example systems described herein and may execute portions of example methods described herein. Thus, whether implemented in hardware, software, firmware, and/or combinations thereof, parallelization logic 530 and computer 500 may provide means (e.g., logics, processes) for selecting, in parallel, candidate loads to satisfy a set of orders, means (e.g., logics, processes) for selecting final loads from the candidate loads and means (e.g., logics, processes) for selectively, in parallel, optimizing the final loads into a transportation plan. While parallelization logic 530 is illustrated as a separate logic, in one example, copies of parallelization logic 530 may be stored on disk 506 and/or in memory 504.

Generally describing an example configuration of computer 500, processor 502 can be a variety of various processors including dual microprocessor and other multi-processor architectures. Memory 504 can include volatile memory and/or non-volatile memory. Disk 506 may be operably connected to computer 500 via, for example, an input/output interface (e.g., card, device) 518 and an input/output port 510. Disk 506 can include, but is not limited to, devices like a magnetic disk drive, a solid state disk drive, a floppy disk drive, a tape drive, a Zip drive, a flash memory card, and/or a memory stick. Furthermore, disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. Disk 506 and/or memory 504 can store an operating system that controls and allocates resources of computer 500.

Bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet).

Computer 500 may interact with input/output devices via i/o interfaces 518 and input/output ports 510. Input/output devices can include, but are not limited to, a keyboard, a microphone, a pointing and selection device, cameras, video cards, displays, disk 506, network devices 520, and the like. Input/output ports 510 can include but are not limited to, serial ports, parallel ports, and USB ports.

Computer 500 can operate in a network environment and thus may be connected to network devices 520 via i/o devices 518, and/or i/o ports 510. Through network devices 520, computer 500 may interact with a network. Through the network, computer 500 may be logically connected to remote computers. The networks with which computer 500 may interact include, but are not limited to, a local area network (LAN), a wide area network (WAN), and other networks. Network devices 520 can connect to LAN technologies including, but not limited to, fiber distributed data interface (FDDI), copper distributed data interface (CDDI), Ethernet (IEEE 802.3), token ring (EEE 802.5), wireless computer communication (IEEE 802.11), Bluetooth (IEEE 802.15.1), and the like. Similarly, network devices 520 can connect to WAN technologies including, but not limited to, point to point links, circuit switching networks like integrated services digital networks (ISDN), packet switching networks, and digital subscriber lines (DSL).

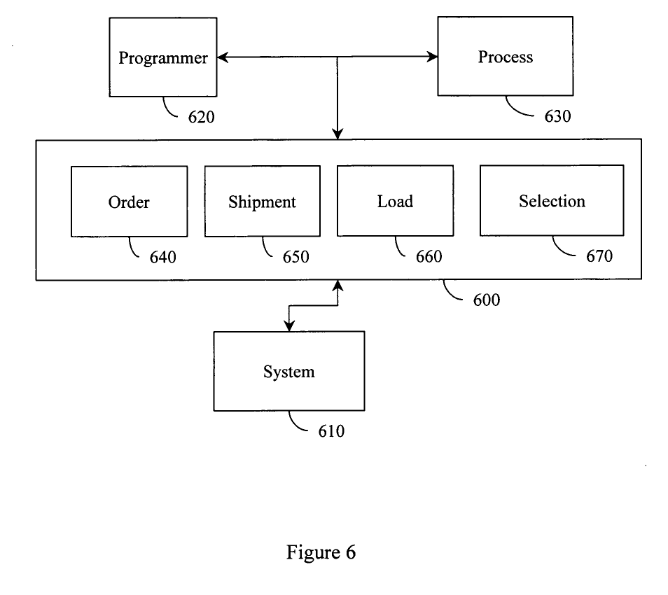

Referring now to FIG. 6, an application programming interface (API) 600 is illustrated providing access to a system 610 that performs transportation planning with parallel optimization. API 600 can be employed, for example, by a programmer 620 and/or a process 630 to gain access to processing performed by system 610. For example, a programmer 620 can write a program to access system 610 (e.g., invoke its operation, monitor its operation, control its operation) where writing the program is facilitated by the presence of API 600. Rather than programmer 620 having to understand the internals of system 610, programmer 620 merely has to learn the interface to system 610. This facilitates encapsulating the functionality of system 610 while exposing that functionality.

API 600 can be employed to provide data values to system 610 and/or retrieve data values from system 610. For example, a process 630 that identifies selected loads can provide selection data to system 610 via API 600 by, for example, using a call provided in API 600. Thus, in one example of API 600, a set of application programming interfaces can be stored on a computer-readable medium. The interfaces can include, but are not limited to, a first interface 640 that communicates an order data including, for example, commodity data, a pickup window, a delivery window, an origin, a destination, and so on. The interfaces may also include a second interface 650 that communicates a shipment data including, for example, a set of orders, a pickup window, a delivery window, an origin, a destination, and so on. The interfaces may also include a third interface 660 that communicates a load data including, for example, a start time, a sequence of stops, and so on. The interfaces may also include a fourth interface 670 for communicating a selection data including, for example, loads that have been selected for inclusion in the transportation plan and loads that are to be excluded from the transportation plan.

FIG. 7 illustrates example consolidation possibilities. Consolidation possibilities may include, for example, simple consolidation 710 where orders with a common source and destination are placed on the same truck. Consolidation possibilities may also include single tier pooling like inbound pooling 720 where orders for a common destination are brought to a consolidation point, consolidated, and sent to the common destination. Consolidation possibilities may also include outbound pooling 730 where orders having a common source but different destinations are sent to a deconsolidation point and then broken down into smaller shipments. Pooling may also include multi-tier pooling 740 and cross-docking 750. In one example, pooling points may be selected by logics operating in parallel based on factors like origin neighborhoods, destination neighborhoods, and so on. In one example, orders may be selected to participate in pooling based on factors like order size, distance from origin to a pooling point, distance from destination to a pooling point, and so on.

FIG. 8 illustrates other load consolidation scenarios. These possibilities include, for example, a multi-stop load 810 and a compound pooling, multi-stop load 820. In 810, a truck may make four stops including a pickup at A, and deliveries at B, C, and D. Additionally, at D, rather than live (un)loading, the trailer may be dropped off and another trailer may be picked up. In 820, a truck may make a pickup at Q, a delivery of a single shipment at R, a delivery of several shipments for several different destinations at deconsolidation point S, and then drop the trailer at T.

FIG. 9 illustrates an example processing flow 900 that includes three example processing sequences that may be executed in parallel to facilitate transportation planning. As various actions are taken, candidate trips may be added to a data store 999 and/or may be read from data store 999. The actions may include actions like splitting orders 910, consolidating shipments 915 and 935, determining pooling points and orders to be affected by local pooling 920, determining multi-stop trips 925 and 940, determining orders to be affected by global pooling 930, selecting carriers and rating trips based on the selected carriers 945, partitioning the set of candidate trips into possible sets of trips 950, and determining continuous moves. While ten actions are illustrated, it is to be appreciated that a greater and/or lesser number of actions may be employed.

A first processing path (illustrated on the left hand side of FIG. 9) through the actions may include actions 910, 915, 930, 935, 940, 945, 950, and 955. A second processing path (illustrated in the left center of FIG. 9) may include actions 910, 915, 920, 925, 930, 935, 940, 945, 950, and 955. A third processing path (illustrated in the center of FIG. 9) may include actions 910, 915, 925, 930, 935, 940, 945, 950, and 955. While three paths are illustrated, it is to be appreciated that a greater and/or lesser number of paths may be employed.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A transportation planning system, comprising:
a data store configured to store a set of orders for which a transportation plan is to be computed, the data store also being configured to store a shipping model;
a first logic operably connected to the data store, the first logic being configured to produce a first set of candidate sub-solutions that cover one or more orders, where the first logic is configured to employ one or more first processes for producing the first set of sub-solutions;
one or more second logics operably connected to the data store, the second logics being configured to produce one or more second sets of candidate sub-solutions that cover one or more orders, where the second logics are configured to employ one or more second processes for producing the second sets of sub-solutions; and
a third logic operably connected to the first logic, the second logic, and the data store, the third logic being configured to select a set of sub-solutions from the first set of candidate sub-solutions and from the second sets of candidate sub-solutions, where the selected set of sub-solutions satisfy the set of orders once and only once and where the selected set of sub-solutions satisfies a transportation planning threshold utility, the third logic being configured to logically remove orders from the set of orders and to add a load associated with a sub-solution to the transportation plan;
the first logic, second logics, and third logic being configured to operate substantially in parallel.

2. The system of claim 1, the first logic, second logic, and third logic being configured to operate sequentially.

3. The system of claim 1, where the shipping model includes data concerning one or more of, a carriage mode, a carrier, a carriage rate, a facility, and a transportation network.

4. The system of claim 3, where the first logic employs one or more of a linear programming process, a simplex method process, a dynamic programming process, a greedy process, a look ahead process, a divide and conquer process, a branch and bound process, a savings-based process, and a heuristic-based process to perform one or more of, simple consolidation, complex consolidation, route planning, local pooling point selection, global pooling point selection, load repairing, load scheduling, carrier selection, and trip rating.

5. The system of claim 4, where route planning includes identifying one or more of, a direct load, a multi-stop load, a load that visits a pooling point, and a continuous move load.

6. The system of claim 5, where the second logics employ one or more of, linear programming processes, simplex method processes, dynamic programming processes, greedy processes, look ahead processes, divide and conquer processes, branch and bound processes, savings-based processes, and heuristic-based processes to perform one or more of, simple consolidation, complex consolidation, route planning, pooling point selection, load repairing, load scheduling, carrier selection, and trip rating.

7. The system of claim 6, including a post-selection optimization logic configured to manipulate selected sub-solutions to improve a utility measurement associated with the transportation plan.

8. A computer implemented transportation planning method, comprising:
accessing a set of orders;
accessing a transportation planning model;
selectively splitting into two or more shipments orders whose size exceeds a threshold size, each of the shipments being less than the threshold size;
selectively consolidating into one shipment two or more shipments having a same source and a same destination, the one shipment being less than the threshold size;
assigning a shipment to a direct load;
determining a lowest rate for the direct load;
for orders that are not associated with a load, performing in parallel two or more sequences that include two or more of:
{
selecting orders to be considered for loads influenced by local pooling;
determining first multi-stop loads that satisfy one or more orders, where the first multi-stop loads visit a pooling point;
selecting orders to be considered for loads influenced by global pooling;
determining second multi-stop loads that satisfy one or more orders, where the second multi-stop loads visit a pooling point;
selectively consolidating into one shipment two or more shipments that have at least two common points;
selecting a primary carrier for a load; and
using the primary carrier to rate the load;
};
identifying a set of loads that satisfies a threshold amount of orders;
selectively removing a load from the set of loads upon determining that the load provides duplicate coverage for an order;
determining continuous move loads from loads in the set of loads;
selectively locally repairing a carrier selection for a load;
scheduling the set of loads into a scheduled set of loads; and
providing an actionable plan of loads from the scheduled set of loads.

9. The method of claim 8, where an order includes data concerning one or more of, a commodity to be shipped, an earliest pickup time, an earliest delivery time, a latest pickup time, a latest delivery time, a source, and a destination.

10. The method of claim 8, where a shipment is assigned to a direct load based, at least in part, on a bin-picking heuristic.

11. The method of claim 8, where splitting orders, consolidating shipments, assigning shipments to loads, selecting orders to participate in pooling, determining loads, selecting carriers, repairing loads, and scheduling loads is performed by one or more of, linear programming processes, simplex method processes, dynamic programming processes, greedy algorithm processes, look ahead processes, divide and conquer processes, branch and bound processes, savings-based processes, and heuristic-based processes.

12. The method of claim 8, where members of the set of orders are selected to be considered for loads influenced by local pooling based, at least in part, on an order size, a distance from an origin to a pooling point, or a distance from a destination to a pooling point.

13. The method of claim 8, where the one or more second multi-stop loads are determined based, at least in part, on an origin neighborhood or a destination neighborhood.

14. The method of claim 13, where the first multi-stop loads and the second multi-stop loads include a load determined as a single pickup, multiple drop off load based, at least in part, on a single origin vehicle routing problem (VRP) heuristic, a load determined as a multiple pickup, single drop off load based, at least in part, on a single destination VRP heuristic, or a load determined from an existing load, where the existing load is expanded to accommodate a new delivery based, at least in part, on a pickup/drop-off problem (PDP) heuristic.

15. The method of claim 8, where members of the set of orders are selected to be considered for loads influenced by global pooling based, at least in part, on a mixed integer problem (MIP) model.

16. The method of claim 8, where selecting a primary carrier includes considering one or more carrier related constraints including carrier availability, carrier discount, carrier commitments, and carrier/product compatibility.

17. The method of claim 8, where the actionable plan of loads satisfies a threshold percentage of the orders once and only once and is based, at least in part, on a mixed integer problem (MIP) set partition model.

18. The method of claim 8, where determining a continuous move load includes:
upon identifying that an additional move will improve a utility measure for a continuous move load, adding the additional move to the continuous move load; and
continuing to evaluate additional moves until no additional move can be identified that would improve the utility measure for the continuous move load beyond a threshold improvement amount.

19. The method of claim 8, where locally repairing carrier selection for a load includes:
identifying a carrier related constraint that is violated for a load or a carrier commitment rule that is broken for a load; and
repairing the violated constraint or broken rule.

20. The method of claim 8, where scheduling a load includes one or more of, manipulating the timing of a load based on one or more of, a carrier, a service, a mode, a lane, an order pickup window, an order drop-off window, a precedence relationship between order legs, a facility loading speed, a facility unloading speed, a facility required flow thru time, and a federal layover regulation rule.

21. A computer-readable medium storing computer executable instructions operable to perform the method of claim 8.

22. A computer implemented transportation planning method, comprising:
accessing a set of orders, where an order includes data concerning one or more of, a commodity to be shipped, an earliest pickup time, an earliest delivery time, a latest pickup time, a latest delivery time, a source, and a destination;
accessing a transportation planning model;
selectively splitting into two or more shipments orders whose size exceeds a threshold size, each of the shipments being less than the threshold size;
selectively consolidating into one shipment two or more shipments having a same source and a same destination, the one shipment being less than the threshold size;
assigning a shipment to a direct load based, at least in part, on a bin-picking heuristic;
determining a lowest rate for the direct load;
for orders that are not associated with a load, performing in parallel two or more sequences that include two or more of:
{
selecting orders to be considered for loads influenced by local pooling based, at least in part, on an order size, a distance from an origin to a pooling point, or a distance from a destination to a pooling point;
determining first multi-stop loads that satisfy orders based, at least in part, on an origin neighborhood or a destination neighborhood, where the first multi-stop loads visit a pooling point;
selecting orders to be considered for loads influenced by global pooling, based, at least in part, on a mixed integer problem (MIP) model;
determining second multi-stop loads that satisfy orders, where the second multi-stop loads visit a pooling point;
selectively consolidating into one shipment two or more shipments that have at least two common points;
selecting a primary carrier for a load, based, at least in part, on considering one or more carrier related constraints including carrier availability, carrier discount, carrier commitments, and carrier/product compatibility; and
using the primary carrier to rate the load;
};
identifying a set of loads that satisfies a threshold amount of orders;
selectively removing a load from the set of loads upon determining that the load provides duplicate coverage for an order;
determining continuous move loads from loads in the set of loads, where determining a continuous move load includes:
upon identifying that an additional move will improve a utility measure for a continuous move load, adding the additional move to the continuous move load; and
continuing to evaluate additional moves until no additional move can be identified that would improve the utility measure for the continuous move load beyond a threshold improvement amount;
selectively locally repairing a carrier selection for a load by identifying a carrier related constraint that is violated for a load or a carrier commitment rule that is broken for a load and repairing the violated constraint or broken rule;
scheduling the set of loads into a scheduled set of loads, where scheduling a load includes one or more of, manipulating the timing of a load based on one or more of, a carrier, a service, a mode, a lane, an order pickup window, an order drop-off window, a precedence relationship between order legs, a facility loading speed, a facility unloading speed, a facility required flow thru time, and a federal layover regulation rule; and
providing an actionable plan of loads from the scheduled set of loads, where the actionable plan of loads satisfies a threshold percentage of the orders once and only once and is based, at least in part, on a mixed integer problem (MIP) set partition model;
where splitting orders, consolidating shipments, assigning shipments to loads, selecting orders to participate in pooling, determining loads, selecting carriers, repairing loads, and scheduling loads is performed by one or more of, linear programming processes, simplex method processes, dynamic programming processes, greedy algorithm processes, look ahead processes, divide and conquer processes, branch and bound processes, savings-based processes, and heuristic-based processes.

23. A computer implemented transportation planning method, comprising:
in parallel, generating a set of candidate loads to satisfy a set of orders;
selecting a set of final loads from the set of candidate loads; and
in parallel, manipulating the set of final loads to reduce a transportation cost associated with satisfying the set of orders.

24. The method of claim 23, where generating the set of candidate loads includes performing one or more of, splitting orders, consolidating orders, determining direct loads, determining multi-stop loads, selecting pooling points, and determining loads that include pooling points.

25. The method of claim 24, where manipulating the set of final loads includes performing one or more of, selecting a carriage mode, selecting a carrier, and determining a schedule.

26. A set of application programming interfaces embodied on a computer-readable medium for execution by a computer component in conjunction with performing parallel optimization in transportation planning, comprising:
a first interface for communicating an order data;
a second interface for communicating a shipment data;
a third interface for communicating a load data; and
a fourth interface for communicating a selection data.

27. A system, comprising:
means for selecting, in parallel, candidate loads to satisfy a set of orders;
means for selecting final loads from the candidate loads; and
means for selectively optimizing the final loads into a transportation plan that reduces a transportation cost, the optimizing being performed in parallel.
